(19) United States
(12) Patent Application Publication
(10) Pub. No.: US 2026/0084620 A1
(43) Pub. Date: Mar. 26, 2026

(54) CAMERA MONITOR SYSTEM WITH PROJECTION DISPLAYS

(71) Applicant: Stoneridge Electronics AB, Solna (SE)

(72) Inventors: Banuprakash Murthy, Novi, MI (US); Tom Agnello, Northville, MI (US); Girikrishna Talla, Novi, MI (US); Gabriel Lepage, Royal Oak, MI (US)

(21) Appl. No.: 18/891,110

(22) Filed: Sep. 20, 2024

(51) Int. Cl. B60R 1/26; H04N 7/18; H04N 9/31

(52) U.S. Cl. CPC B60R 1/26; H04N 7/181; H04N 9/3141; B60R 2300/105; B60R 2300/20; B60R 2300/304; B60R 2300/8066

(57) ABSTRACT

A camera monitor system (CMS) for a vehicle includes at least one rear-facing camera that is configured to capture images from a field of view alongside the vehicle. At least one display depicts the captured images to an operator and includes a transparent medium that has at least one display area. A projector that is configured to project the captured images on the display area. A controller is in communication with the at least one camera and the projector. The controller is configured to command the projector to depict the captured images in response to a vehicle operating parameter.

### TECHNICAL FIELD

This disclosure relates to a camera monitor system (CMS), and more particularly, to a method and apparatus for using projection displays in a manner that is useful in a CMS.

### BACKGROUND

Vehicle camera systems for mirror replacement or for supplementing mirror views are utilized in commercial vehicles to enhance the ability of a vehicle operator to see a surrounding environment of the commercial vehicle. Camera monitor systems (CMS) utilize one or more cameras to provide an enhanced field of view to a vehicle operator. In some examples, the mirror replacement systems cover a larger field of view than a conventional mirror, or include views that are not fully obtainable via a conventional mirror.

There is a desire to improve operator visibility to reduce risk. One approach is to add more cameras and more displays to increase the viewable area around the vehicle. The number of displays may proliferate in a CMS as more cameras are added and more information is provided to the operator, which may make assimilating the information more challenging. Monitors that are mounted in the vehicle cabin to depict captured images from the cameras may obstruct the operator's line of sight to the vehicle's exterior.

### SUMMARY

In one example embodiment, a camera monitor system (CMS) for a vehicle includes at least one rear-facing camera that is configured to capture images from a field of view alongside the vehicle. At least one display depicts the captured images to an operator and includes a transparent medium that has at least one display area. A projector that is configured to project the captured images on the display area. A controller is in communication with the at least one camera and the projector. The controller is configured to command the projector to depict the captured images in response to a vehicle operating parameter.

In a further example embodiment of any of the foregoing embodiments, the at least one display area is located near an A-pillar of the vehicle. The depicted captured images include a wide angle view and a narrow angle view.

In a further example embodiment of any of the foregoing embodiments, the at least one display area includes a first display area and a second display area. The first display area is arranged near an operator-side A-pillar, and the second display area is arranged near a passenger-side A-pillar.

In a further example embodiment of any of the foregoing embodiments, the first display area has at least a portion within 6 inches of the operator-side A-pillar, and the at least one rear-facing camera includes an operator-side camera that is configured to capture images from an operator-side field of view alongside the vehicle.

In a further example embodiment of any of the foregoing embodiments, the second display area is entirely at least 6 inches away from the passenger-side A-pillar, and the at least one rear-facing camera includes a passenger-side camera that is configured to capture images from a passenger-side field of view alongside the vehicle.

In a further example embodiment of any of the foregoing embodiments, the projector is mounted to an instrument panel.

In a further example embodiment of any of the foregoing embodiments, the projector is mounted to a headliner.

In a further example embodiment of any of the foregoing embodiments, the projector is mounted to the A-pillar.

In a further example embodiment of any of the foregoing embodiments, the CMS includes another camera that is configured to capture other captured images from another field of view corresponding to a front corner area of the vehicle on an opposite side of the operator and aftward. The at least one display area includes another display area, and another projector is configured to project the other captured images on the display area.

In a further example embodiment of any of the foregoing embodiments, the CMS includes another camera that is configured to capture other captured images from another field of view corresponding to a front corner area of the vehicle on an opposite side of the operator and along a front of the vehicle. The at least one display area includes another display area, and another projector is configured to project the other captured images on the display area.

In a further example embodiment of any of the foregoing embodiments, the CMS includes another camera that is configured to capture other captured images from another field of view corresponding to rear-facing trailer view. The at least one display area includes another display area, and another projector is configured to project the other captured images on the display area.

In a further example embodiment of any of the foregoing embodiments, the controller is configured to depict an overlay onto the captured images.

In a further example embodiment of any of the foregoing embodiments, the at least one display area includes a heads-up display (HUD) display area arranged behind and above a steering wheel relative to the operator, and a HUD projector depicting information onto the HUD display area.

In a further example embodiment of any of the foregoing embodiments, the CMS includes a driver information display that is mounted to the instrument panel. The driver information display is arranged behind the steering wheel.

In another example embodiment, a method of providing views in a camera monitor system (CMS) for a vehicle includes capturing images from a field of view alongside the vehicle with at least one rear-facing camera, the captured images include a wide angle view and a narrow angle view, and projecting the wide angle view and the narrow angle onto at least one display area of a transparent medium.

In a further example embodiment of any of the foregoing embodiments, the at least one display area includes a first display area and a second display area. The first display area is arranged near an operator-side A-pillar, and the second display area is arranged near a passenger-side A-pillar. The first display area has at least a portion within 6 inches of the operator-side A-pillar, and the at least one rear-facing camera includes an operator-side camera that is configured to capture images from an operator-side field of view alongside the vehicle, and the projector is configured to project the operator-side captured images on the first display area. The second display area is entirely at least 6 inches away from the passenger-side A-pillar, and the at least one rear-facing camera includes a passenger-side camera that is configured to capture images from a passenger-side field of view alongside the vehicle, and another projector is configured to project the passenger-side captured images on the second display area.

In a further example embodiment of any of the foregoing embodiments, the projector and the other projector are each mounted to one of an instrument panel, a headliner, and the A-pillar.

In a further example embodiment of any of the foregoing embodiments, the method includes another camera that is configured to capture other captured images from another field of view corresponding to a front corner area of the vehicle on an opposite side of the operator and aftward. The at least one display area includes another display area, and another projector is configured to project the other captured images on the display area.

In a further example embodiment of any of the foregoing embodiments, the method includes another camera that is configured to capture other captured images from another field of view corresponding to a front corner area of the vehicle on an opposite side of the operator and along a front of the vehicle. The at least one display area includes another display area, and another projector is configured to project the other captured images on the display area.

In a further example embodiment of any of the foregoing embodiments, the method includes another camera that is configured to capture other captured images from another field of view corresponding to rear-facing trailer view. The at least one display area includes another display area, and another projector is configured to project the other captured images on the display area.

These and other features of the present invention can be best understood from the following specification and drawings, the following of which is a brief description.

### BRIEF DESCRIPTION OF THE DRAWINGS

The disclosure can be further understood by reference to the following detailed description when considered in connection with the accompanying drawings wherein:

FIG. 1 is a prior art schematic front view of a commercial truck with a camera mirror system (CMS) used to provide at least narrow and wide fields of view alongside the vehicle (e.g., Class II and Class IV views).

FIG. 2 is a prior art schematic birds-eye view of the commercial truck of FIG. 1 with a CMS providing, for example, Class II, Class IV, Class V, Class VI, and Class VIII views.

FIG. 3 is a prior art schematic top view of an example vehicle cabin interior.

FIG. 4 is a prior art perspective view of an example vehicle cabin interior.

FIG. 5 is a schematic perspective view of an example vehicle cabin interior with the disclosed projection displays.

FIG. 6 is an example perspective view of a vehicle cabin interior with several disclosed projection displays.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

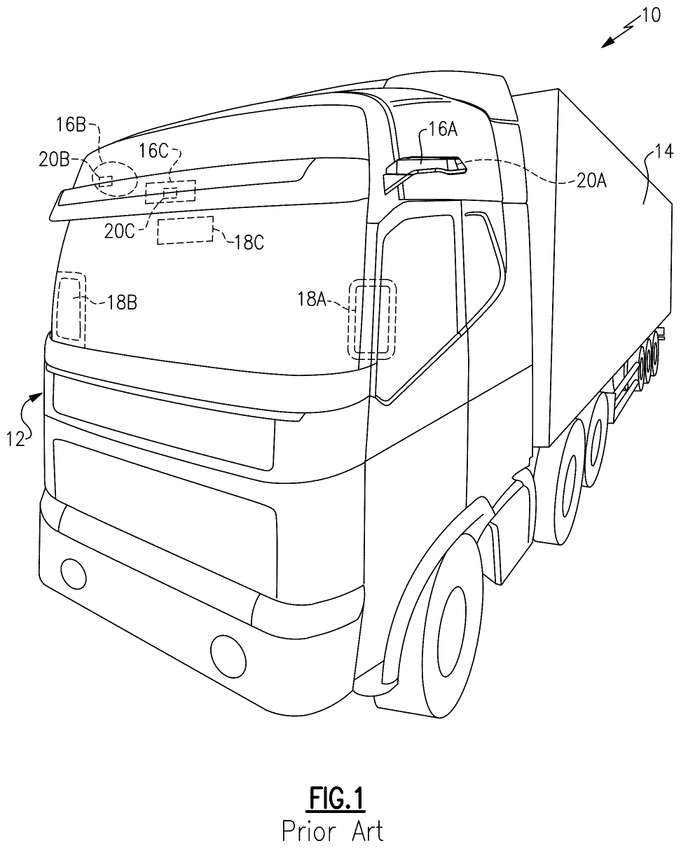

Schematic views of a commercial vehicle 10 are illustrated in FIGS. 1-4. The commercial vehicle 10 includes a vehicle cab or “tractor” 12 for pulling a trailer 14, where the trailer 14 articulates with respect to the tractor 12 during turns. Although the commercial vehicle 10 is depicted as a commercial truck with a single trailer in this disclosure, it is understood that other commercial vehicle configurations may be used (e.g., different types or quantities of trailers).

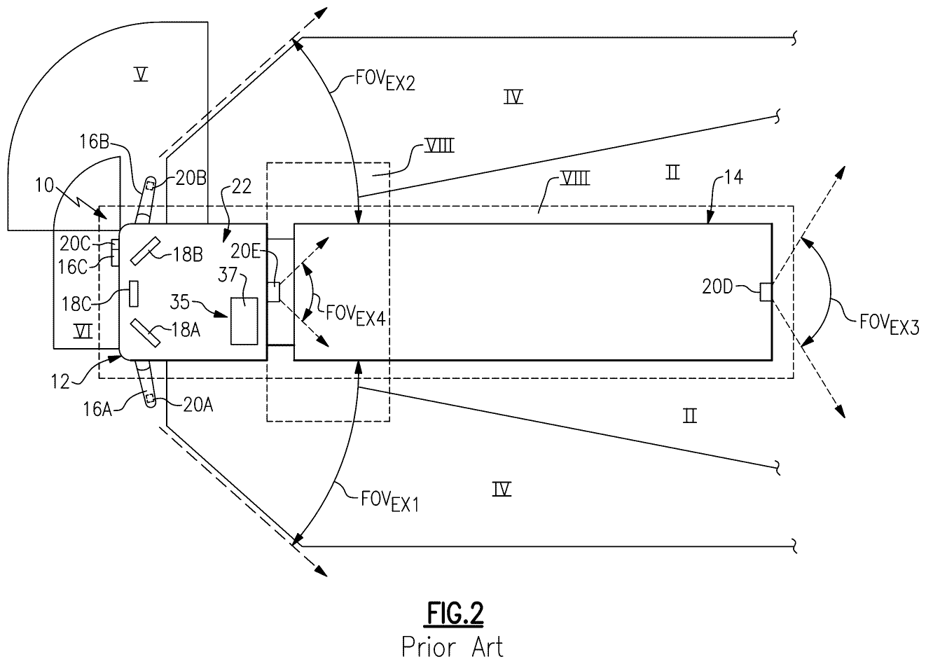

A pair of camera arms 16A-B include a respective base that is secured to, for example, the tractor 12. A pivoting arm is supported by the base and may articulate relative thereto. At least one rearward facing camera 20A-B is arranged respectively on or within the camera arms 16A-B. The exterior cameras 20A-B respectively provide an exterior field of view FOV_{EX1}, FOV_{EX2} that each include at least one of Class II and Class IV views (FIG. 2), which are legally prescribed views in the commercial trucking industry.

The Class Il view on a given side of the commercial vehicle 10 is a subset of the class IV view of the same side of the commercial vehicle 10. Multiple cameras also may be used in each camera arm 16A-B to provide these views, if desired. Class II (narrow) and Class IV (wide angle) views are defined in European R46 legislation, for example, and the United States and other countries may have similar driver visibility requirements for commercial trucks. Any reference to a “Class” view is not intended to be limiting, but is intended as an example of the type of view provided to a display from a particular camera. For example, certain views may be prescribed in SAE J3155 or other regulations.

Each camera arm 16A-16B may also provide a housing that encloses electronics, e.g., a controller, that are configured to provide various features of the CMS 15. The camera arms 16A-B may be mounted either at a roof-mount location over the cab door (as shown), or on a door-mounted bracket or station, for example. If desired, the camera arms 16A-B may include conventional mirrors integrated with them as well, although the CMS 15 may be used to entirely replace mirrors. In additional examples, each side can include multiple camera arms, with each arm housing one or more cameras and/or mirrors.

If video of Class V and/or Class VI views is also desired, a camera housing 16C and camera 20C may be arranged at or near the front of the commercial vehicle 10 to provide those views (FIG. 2). Generally, Class V covers a passenger side of the vehicle from a passenger vehicle cab corner aftward along a cab of the vehicle, and Class VI covers a passenger side of the vehicle from a passenger vehicle cab corner along a front of a cab of the vehicle.

A backup camera, or trailer rearview camera, 20D may be provided which provides a field of view FOV_{EX3}. The trailer rearview camera 20D may be mounted at a top/centerline of the trailer, at a bumper/bed level of the trailer, or at a top-corner of the back of the trailer, for example. Alternatively, or in addition to the rear trailer camera, a “fifth wheel camera” 20E may be provided that is mounted to a rear of the tractor 12 and that provides a field of view FOV_{EX4}. The fifth wheel camera 20E may be mounted anywhere between the lateral plane of the fifth wheel fixture and the top/roof edge of the tractor, for example.

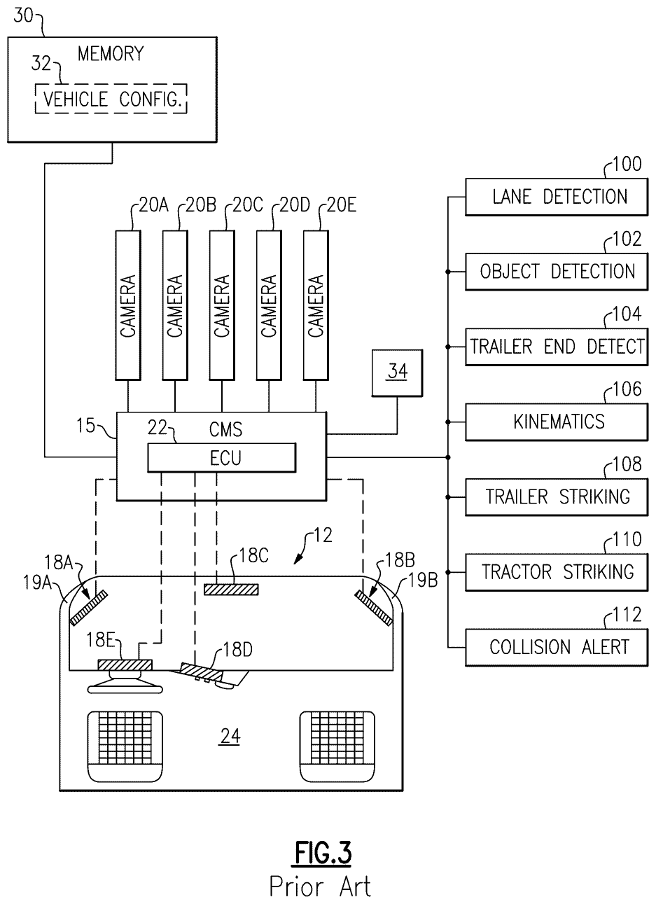

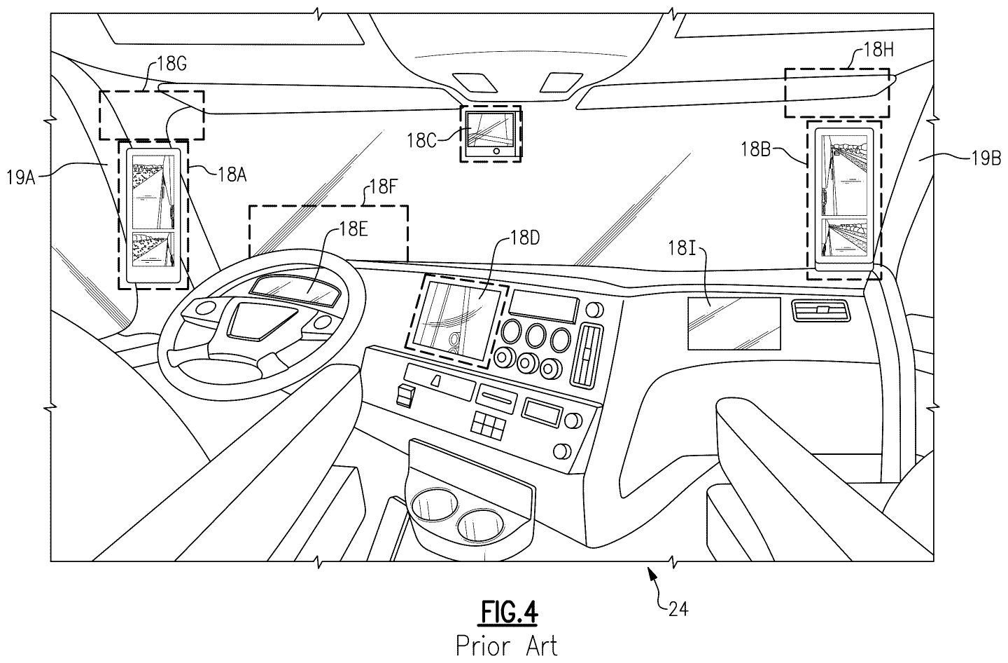

FIG. 3 is a schematic top view of an example vehicle cabin interior 24, and FIG. 4 is a perspective view of the vehicle cabin interior 24. Referring now to FIGS. 3-4 with continued reference to FIGS. 1-2, electronic displays 18A-E (e.g., which may be video displays, such as LCD displays) and cameras 20A-E (generally, “camera 20”) are shown. The various electronic displays 18A-E and cameras 20A-E are part of a camera monitor system (CMS) 15, and therefore act as CMS displays and CMS cameras. As used herein, a “CMS camera” 20 is a camera configured to record images of an environment surrounding a commercial vehicle 10, and a “CMS display” 18 is an electronic display (e.g., an LCD) that is configured to image or display feeds from those cameras.

FIG. 4 illustrates additional or different displays 18F, 18G, 18H, 18I that may be used to display images from the cameras 20A-E or other cameras. For example, display 18F provides a heads-up-display (HUD) projected in the region of the driver side windshield. A HUD results in an image being visible within the driver's line of sight, either on the windshield or another, separate transparent medium. The image may be achieved through emissive technologies, such as a display integrated within the transparent medium, or projected technologies, such as a projector combined with one or more optical lenses, reflective surfaces, and optical films. In this disclosure, “HUD” refers to technologies incorporating a projector. Information provided on the display can be vehicle information (e.g., speed, navigation) or such information as described in International Application No. PCT/EP2024/059172 filed on Dec. 11, 2023, entitled “CAMERA MONITOR SYSTEM WITH HEADS UP DISPLAY FEATURES,” which is incorporated herein by reference in its entirety

Displays 18G, 18H may be provided respectively on the A-pillars 19A, 19B to provide additional views to those of the displays 18A, 18B. An additional display 18I may be provided on the passenger side. Fewer, more or different displays and/or configurations may be used. The displays 18A-18E and 18G-18I, to the extend present in the prior art, would be provided by monitors, such as LCD, LED, OLED, plasma.

The CMS 15 includes a CMS controller or electronic control unit (ECU) 22 includes processing circuitry that supports operation of the CMS 15. The CMS ECU 22 is operatively connected to memory (which may include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). The processing circuitry may include one or more microprocessors, microcontrollers, application specific integrated circuits (ASICs), or the like.

The CMS displays 18A-B are arranged on each of the driver and passenger sides within the vehicle cab 12 on or near the A-pillars 19A-B to display Class II and Class IV views on its respective side of the commercial vehicle 10, which provide rear facing side views along the commercial vehicle 10 that are captured by the exterior cameras 20A-B. In a left-hand drive or center-drive vehicle, the left A-pillar 19A is the operator side and the right-hand A-pillar 19B is the passenger side. For a right-hand drive vehicle, the operator and passenger sides are the opposite.

As discussed above, if video of Class V and Class VI views are also desired, the camera housing 16C and camera 20C may be arranged at or near the front of the commercial vehicle 10 to provide those views (FIG. 2). In the example of FIG. 3, additional displays 18C-E are provided. Display 18C is arranged in the vehicle cabin interior 24 near the top center of the windshield (or separate transparent medium) may be used to display the Class V and Class VI views, which are toward the front of the commercial vehicle 10, or a rear camera view (from camera 20D or 20E) to the driver. Display 18D is provided in a center console area of the vehicle cabin interior 24, generally located centrally in a bottom half of the vehicle cabin, and may be used for other purposes, such as navigation, infotainment, etc (i.e., a secondary information display (SID)).

Display 18E may be part of an instrument cluster (i.e., a primary or driver information display (DIS)) mounted in an instrument panel located behind the steering wheel, for example. The DIS 18E is configured to the depict vehicle operating information, such as at least one of a vehicle speed and an engine rotational speed. Other example vehicle operating information such, as odometer, trip odometer, fuel economy, vehicle and/or engine maintenance information, vehicle telltales (e.g., warning lights, malfunction lights, status lights (e.g., turn signals), etc. for tractor and/or trailer).

If video of Class VIII views is desired, camera housings can be disposed at the sides and rear of the commercial vehicle 10 to provide fields of view including some or all of the Class VIII zones of the commercial vehicle 10. In such examples, one of the displays 18C-E may include one or more frames displaying the Class VIII views. The displays 18A, 18B, 18C face a driver region 35 within the vehicle cabin interior 24 where an operator is seated on a driver seat 37.

In various examples, the ECU 22 includes one or modules having algorithm(s), equation(s) and/or decision manager(s) that receive input(s) from sensors (e.g., cameras 20A-20E, ultrasonic, LiDar, radar, etc.) and/or stored values, as schematically illustrated in FIG. 3. Example modules include Lane Detection Module 100, Object Detection Module 102, Trailer End Detection Module 104, Kinematic Module 106, Trailer Striking Area Prediction Module 108, Tractor Striking Area Prediction Module 110, and Collision Alert Module 112. Example inputs include one or more sensors 34, such as a steering angle sensor, a vehicle speed sensor, gear position sensor, and/or other sensor data. Vehicle configuration information 32, which may be stored in memory 30, relates to vehicle characteristics (e.g., trailer length, axle position, trailer type/wheelbase, tractor configuration/wheelbase, hitch point location etc.), provided by the manufacturer, operator, and/or determined by one or more of the modules. During vehicle operation, the ECU 22 may communicate information to the driver, fleet operator, or others using an output (e. g, displays 18, speaker, etc.). Example operation and uses of these modules are disclosed in International Application No. PCT/US2023/083416 filed on Dec. 11, 2023, entitled “CAMERA MONITOR SYSTEM WITH TRAILER CURB STRIKE ALERT AND TRAILER STRIKING AREA,” which is incorporated herein by reference in its entirety.

The lane detection module 100 also uses image processing of the captured images to identify markings on the roadway, such as lane markers that visually divide adjacent lanes. One example algorithm is described in United States Publication No. US2023/117,719, entitled “CAMERA MIRROR SYSTEM DISPLAY FOR COMMERCIAL VEHICLES INCLUDING SYSTEM FOR IDENTIFYING ROAD MARKINGS”, which is incorporated by reference in its entirely. In that publication, a lane detection module is described in which an object detection algorithm identifies a lane marking in a roadway by filtering a color of the lane marking from a surrounding portion of the captured image. Other techniques based upon deep learning technology or another computer vision method may be used, if desired.

The object detection module 102 includes one or more image processing algorithms configured to identify objects in the captured images. The algorithms may be used to identify VRU's (e.g., pedestrians or cyclists), attributes of the tractor 12 and/or trailer 14, other vehicles, signs, curbs, trees, buildings and/or other inanimate objects.

The trailer end detection module 104 is another image processing module that extracts one or more trailer features from the captured images to determine the location of the end of the trailer in 3D space. These extracted attributes can be used to detect objects such as tractor wheels, trailer edges and other features. Example wheel detection algorithm techniques are disclosed in United States Publication No. US2023/202,394 entitled “CAMERA MONITOR SYSTEM FOR COMMERCIAL VEHICLES INCLUDING WHEEL POSITION ESTIMATION”, which is incorporated herein by reference in its entirety. Example trailer edge detection algorithm techniques are disclosed in United States Publication No. US2023/125,045 entitled “TRAILER END TRACKING IN CAMERA MONITORING SYSTEM”, which is incorporated herein by reference in its entirety. Other techniques may be used, if desired.

In one example operation, the CMS 15 utilizes the kinematics module 106 to predict a striking zone of the trailer 14 during a turn operation and generates a two-dimensional overlay to digitally impose over at least one of the displayed Class II/IV images thereby showing the vehicle operator an expected striking zone of the trailer 14 and allowing the vehicle operator adjust the vehicle operations accordingly. The CMS 15 uses the received captured images from the cameras 20A, 20B, as well as any other cameras and vehicle operation data received from a general vehicle controller through a data connection, such as a CAN or LIN bus, to estimate a predicted position of the tractor and/or trailer side at each of multiple side positions and multiple points in time. These positions are converted to a geometric area encompassing all the positions. In this way, the shape and size of the geometric area is not fixed, but rather reflects an actual predicted striking area of the trailer.

In order to avoid accidental strikes, the striking area prediction system uses the vehicle data (e.g. steering angle, steering rate, trailer angle, vehicle speed, trailer wheelbase, tractor wheelbase, hitch point location, yaw rate and the like) to generate a predicted striking zone over time. The predicted striking zone is a prediction of the path the trailer will take over the course of the turn and is re-calculated continuously as the turn progresses. The trailer striking area is also useful in a potential “curve cut” scenario when the vehicle 10 is traveling down a curved roadway. In a curvy road, it becomes more likely for the trailer end to cross the lane markers. indicating boundaries to adjacent lanes, creating a potentially dangerous situation.

The CMS 15 includes a Decision Manager or Collision Alert Module 112 that communicates with the modules 100-110 to evaluate the proximity between the predicted tractor and/or trailer paths (i.e., the tractor and trailer striking areas) and one or more objects (e.g., predicting an imminent curb strike, curve cut, object collision etc.). The decision manager considers the estimated time to the event, severity (what the object is), closing rate between objects, etc. and may provide an overlay and/or alert.

While various overlays and alerts may useful in increasing operator awareness and enhancing safety, it is desirable to more easily and proactively manage awareness of vehicle surroundings. One or more HUDs can be used to provide CMS views to improve driver visibility by minimizing line-of-sight obstructions that may otherwise occur when using monitors in the cabin.

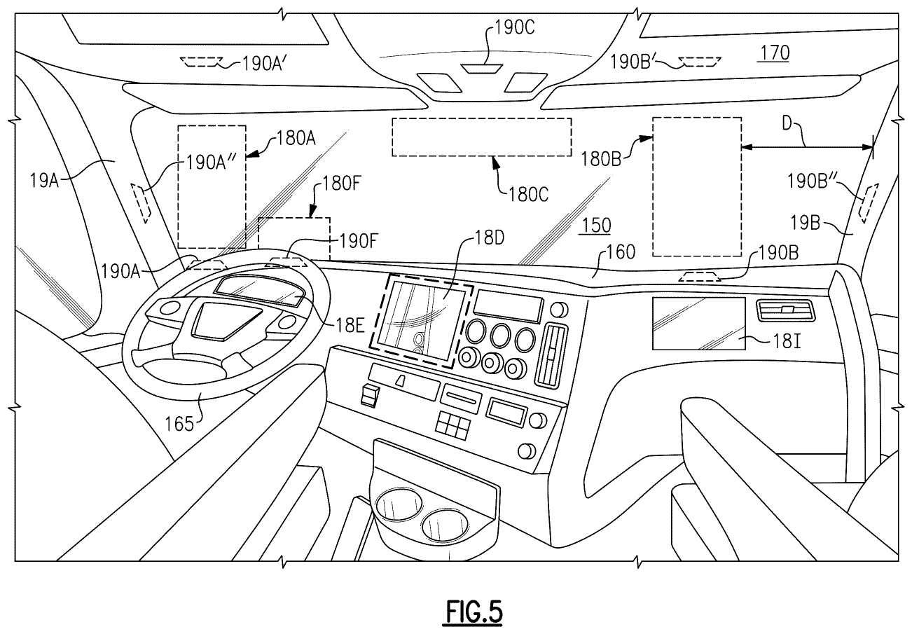

Referring to FIG. 5, a typical vehicle cab includes an instrument panel 160 in front of which is a windshield/windscreen 150. The A-pillars 19A, 19B are arranged laterally on either side of the windshield 150. Behind the instrument panel 160 is a steering wheel 165 within reach of the driver. The cab includes a headliner 170 or roof extending rearward at the top of the A-pillars 19A, 19B.

The windshield (windscreen) 150 may include at least one display area (e.g., 180A-180C, generally, “display area 180”) in conjunction with a projector (e.g., 190A-190C, 190A′-190B′, 190A″-190B″, generally, “projector 190”) to provide captured images from one or more of the camera(s) 20. Here, “windshield” should be understood as any transparent medium through which the driver must view to see outside of the vehicle cabin or optical films or layers. Thus, it should be understood that a transparent member mounted interiorly of the windscreen and inside the vehicle cabin can be used to provide the disclosed display area(s) 180. Incorporating the display area(s) 180 can eliminate any monitors that may block the view of the driver, particularly in the areas inboard of the A-pillars 19A, 19B.

One or more projectors 190 are arranged throughout the vehicle cabin, for example, mounted to the instrument panel 160, mounted to a headliner/roof 170 and/or mounted to the A-pillar(s) 19A, 19B. The controller or ECU 22 is in communication with the CMS cameras 20 and the projector(s) 190. The ECU 22 commands the projector 190 to depict the captured images from one or more of the cameras 20 in one or more display areas 180 in response to a vehicle operating parameter (e.g., vehicle operating conditions, including pre-start, post-start, idle, turning maneuvers, travel, etc.). The ECU 22 may also depict an overlay onto the captured images.

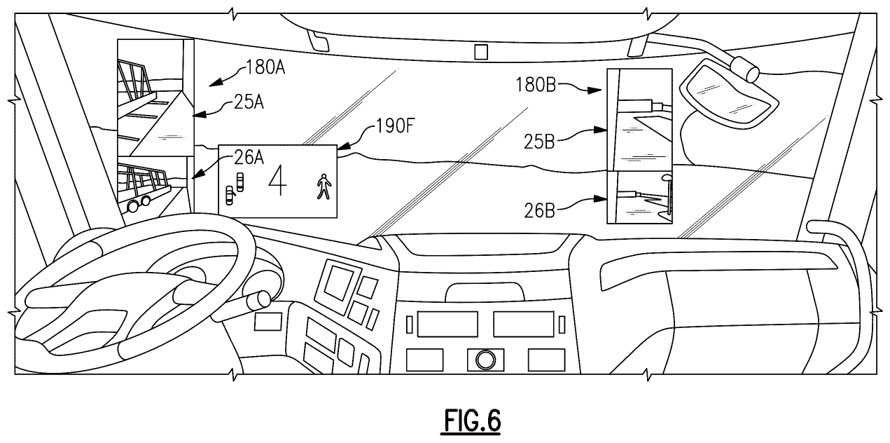

Referring to FIGS. 5 and 6, the rear-facing side views are each projected a display area corresponding to its respective side (left FOV displayed on the left display area 180A; right FOV displayed on the right display area 180B). In the example shown in FIG. 6, each display area 180A-B includes a respective first display area 25A-B and a respective second display area 26A-B. Display area 25A is configured to display a Class II (narrow) view from camera 20A, and display area 26A is configured to display a Class IV (wide) view from camera 20A (or an additional, wide angle camera situated on the same side of the commercial vehicle as camera 20A). Both display areas 25A, 26A may be provided from a single projector or multiple projectors (e.g., 190A, 190A′ and/or 190A″). Similarly, display area 25B is configured to display a Class II (narrow) view from camera 20B, and display area 26B is configured to display a Class IV (wide) view from camera 20B (or an additional, wide angle camera situated on the same side of the commercial vehicle as camera 20B). Both display areas 25B, 26B may be provided from a single projector or multiple projectors (e.g., 190B, 190B′ and/or 190B″).

In the example, the display area 180A is located near A-pillar 19A (e.g., the first display area 180A has at least a portion within 6 inches of the operator-side A-pillar 19A). Locating the display area 190A in close proximity to the A-pillar 19A minimizes distractions to the driver when looking forward. By way of contrast, the second display area 180B is spaced from its nearby A-pillar 19B and closer to the driver to improve the view of the display area 180B (e.g., display area 180B entirely at least 6 inches away from the passenger-side A-pillar 19B). This is possible because there is no longer a monitor that must be mounted in such a way so as to not obstruct the driver's view. As a result, the captured images in the display area 180B are more easily viewed by the driver, leading to quicker assimilation of the displayed images and reduced distraction.

A HUD display area 180F similar to the HUD 18F may be provided in addition to the first and second display areas 180A, 180B. Another display area 180C may be provided in a central, top location to depict additional captured images, for example, from cameras 20C, 20D, and/or 20E. A projector 190C in the headliner 170 or other location may be used to provide the captured images to the display area 190C.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

1. A camera monitor system (CMS) for a vehicle, comprising:
at least one rear-facing camera configured to capture images from a field of view alongside the vehicle;
at least one display configured to depict the captured images to an operator, wherein the at least one display includes:
a transparent medium through which the driver must view to see outside of the vehicle cabin or optical films or layers, the transparent medium having at least one display area;
a projector configured to project the captured images on the display area; and
a controller in communication with the at least one camera and the projector, the controller configured to command the projector to depict the captured images in response to a vehicle operating parameter.

2. The CMS of claim 1, wherein the at least one display area is located near an A-pillar of the vehicle, wherein the depicted captured images include a wide angle view and a narrow angle view.

3. The CMS of claim 2, wherein the at least one display area includes a first display area and a second display area, the first display area arranged near an operator-side A-pillar, and the second display area arranged near a passenger-side A-pillar.

4. The CMS of claim 3, wherein the first display area has at least a portion within 6 inches of the operator-side A-pillar, and the at least one rear-facing camera includes an operator-side camera configured to capture images from an operator-side field of view alongside the vehicle.

5. The CMS of claim 3, wherein the second display area is entirely at least 6 inches away from the passenger-side A-pillar, and the at least one rear-facing camera includes a passenger-side camera configured to capture images from a passenger-side field of view alongside the vehicle.

6. The CMS of claim 2, wherein the projector is mounted to an instrument panel.

7. The CMS of claim 2, wherein the projector is mounted to a headliner.

8. The CMS of claim 2, wherein the projector is mounted to the A-pillar.

9. The CMS of claim 1, comprising another camera configured to capture other captured images from another field of view corresponding to a front corner area of the vehicle on an opposite side of the operator and aftward, the at least one display area includes another display area, and another projector is configured to project the other captured images on the display area.

10. The CMS of claim 1, comprising another camera configured to capture other captured images from another field of view corresponding to a front corner area of the vehicle on an opposite side of the operator and along a front of the vehicle, the at least one display area includes another display area, and another projector is configured to project the other captured images on the display area.

11. The CMS of claim 1, comprising another camera configured to capture other captured images from another field of view corresponding to rear-facing trailer view, the at least one display area includes another display area, and another projector is configured to project the other captured images on the display area.

12. The CMS of claim 1, wherein the controller is configured to depict an overlay onto the captured images.

13. The CMS of claim 1, wherein the at least one display area includes a heads-up display (HUD) display area arranged behind and above a steering wheel relative to the operator, and a HUD projector depicting information onto the HUD display area.

14. The CMS of claim 13, comprising a driver information display mounted to the instrument panel, the driver information display arranged behind the steering wheel.

15. A method of providing views in a camera monitor system (CMS) for a vehicle, comprising:
a) capturing images from a field of view alongside the vehicle with at least one rear-facing camera, wherein the captured images include a wide angle view and a narrow angle view; and
b) projecting the wide angle view and the narrow angle onto at least one display area of a transparent medium through which the driver must view to see outside of the vehicle cabin or optical films or layers.

16. The method of claim 15, wherein the at least one display area includes a first display area and a second display area, the first display area arranged near an operator-side A-pillar, and the second display area arranged near a passenger-side A-pillar;
wherein the first display area has at least a portion within 6 inches of the operator-side A-pillar, and the at least one rear-facing camera includes an operator-side camera configured to capture images from an operator-side field of view alongside the vehicle, and the projector is configured to project the operator-side captured images on the first display area; and
wherein the second display area is entirely at least 6 inches away from the passenger-side A-pillar, and the at least one rear-facing camera includes a passenger-side camera configured to capture images from a passenger-side field of view alongside the vehicle, and another projector is configured to project the passenger-side captured images on the second display area.

17. The method of claim 16, wherein the projector and the other projector are each mounted to one of an instrument panel, a headliner, and the A-pillar.

18. The method of claim 15, comprising another camera configured to capture other captured images from another field of view corresponding to a front corner area of the vehicle on an opposite side of the operator and aftward, the at least one display area includes another display area, and another projector is configured to project the other captured images on the display area.

19. The method of claim 15, comprising another camera configured to capture other captured images from another field of view corresponding to a front corner area of the vehicle on an opposite side of the operator and along a front of the vehicle, the at least one display area includes another display area, and another projector is configured to project the other captured images on the display area.

20. The method of claim 15, comprising another camera configured to capture other captured images from another field of view corresponding to rear-facing trailer view, the at least one display area includes another display area, and another projector is configured to project the other captured images on the display area.
